(19) United States
(12) Patent Application Publication
(10) Pub. No.: US 2014/0113716 A1
(43) Pub. Date: Apr. 24, 2014

(54) Electronic Board Game With Virtual Reality

(71) Applicant: FUNDO LEARNING AND ENTERTAINMENT, LLC, Milford, CT (US)

(72) Inventor: Pralay Mukhopadhyay, Milford, CT (US)

(73) Assignee: Fundo Learning and Entertainment, LLC, Milford, CT (US)

(21) Appl. No.: 13/801,700

(22) Filed: Mar. 13, 2013

Related U.S. Application Data
(60) Provisional application No. 61/716,057, filed on Oct. 19, 2012.

(51) Int. Cl. A63F 13/00

(52) U.S. Cl. CPC A63F 13/00
USPC 463/31

(57) ABSTRACT

Methods and systems for providing an electronic game are described. A method may include electronically displaying a game board on a gaming device display. The game board has a plurality of player movement spaces along a path on the face of the game board. An action of a player on the game board is determined. A challenge is determined for the player based on the action. The challenge is electronically displayed to the player. A challenge response is received from the player using the gaming device. It is determined whether a challenge response is a successful response. Upon determining that the challenge response is a successful response, the method includes switching from displaying a game board to displaying a virtual reality environment on the gaming device display. The virtual reality environment is displayed from a viewpoint that allows navigation within an environment associated with the challenge response.

### CROSS REFERENCE TO RELATED APPLICATIONS

This applications claims the benefit under 35 U.S.C. §119(e) of U.S. Provisional Patent Application No. 61/716,057, entitled “ELECTRONIC BOARD GAME WITH VIRTUAL REALITY,” filed Oct. 19, 2012, which is incorporated herein by reference in its entirety.

### FIELD

The described systems relate generally to electronic games.

### BACKGROUND

Board games have been played by various societies all throughout history. With the advent of computer technology, electronic games have been developed to further entertain game participants. Electronic games can involve many different genres, including electronic versions of popular board games, role-playing games, puzzles and video games. Video games can include sports games, fighting games, mazes, puzzles, first-person shooter games, virtual role-playing games, arcade games and so forth.

Many games have combined entertainment and education. Educational games may be in various formats. For example, board games with trivia questions have been a popular and comfortable format for educational games. However, as video games have become more advanced in appearance and play, educational games have met difficulty in meeting such advanced and modern expectations of game players.

### BRIEF SUMMARY

Methods and systems for providing an electronic game are described. In a general aspect, a method includes electronically displaying a game board on a gaming device display. The game board has a plurality of player movement spaces along a path on the face of the game board. An action of a player on the game board is determined. A challenge is determined for the player based on the action. The challenge is electronically displayed to the player. A challenge response is received from the player using the gaming device. It is determined whether the challenge response is a successful response. Upon determining that the challenge response is a successful response, the method includes switching from displaying a game board to displaying a virtual reality environment on the gaming device display. The virtual reality environment is displayed from a viewpoint that allows navigation within an environment associated with the challenge response.

Other embodiments of this aspect include corresponding systems, apparatus, and computer programs, configured to perform the actions of the methods, encoded on computer storage devices. Further embodiments, features, and advantages, as well as the structure and operation of the various embodiments are described in detail below with reference to accompanying drawings.

### BRIEF DESCRIPTION OF THE FIGURES

Embodiments are described with reference to the accompanying drawings. In the drawings, like reference numbers may indicate identical or functionally similar elements.

FIG. 1 illustrates a block diagram illustrating example devices for playing electronic games.

FIG. 2 further illustrates a more detailed system for providing an electronic game.

FIG. 3 illustrates an example display view of a game board.

FIG. 4 illustrates an example display view of a game challenge.

FIG. 5 illustrates an example display view of a virtual reality environment associated with the game challenge.

FIG. 6 illustrates an example display view of navigation in the virtual reality environment.

FIG. 7 illustrates another example display view of navigation in the virtual reality environment.

FIG. 8 illustrates an example display view of a player action on the game board.

FIG. 9 illustrates a flowchart showing an example process for providing an electronic game.

FIG. 10 is a block diagram of a computer system.

### DETAILED DESCRIPTION

As video games have become more advanced in appearance and play, educational games have met difficulty meeting such advanced and modern expectations of game players. Many board games have very entertaining rules and game play. However, modern video games provide virtual environments and a first person perspective in the environments. These types of virtual reality environments are popular with game players of all ages.

The embodiments described herein provide for an electronic video game that serves strong educational properties of a game board and trivia format in combination with virtual reality environments that are attractive to a wide range of game players. In an example game, not intended to limit the embodiments, a representation of a game board is displayed on a game device video screen. Graphic icons representing the players may move along the face of the board, landing on defined spaces. A space may indicate that a particular challenge is to be presented. In an example, a challenge is presented to a player when the player lands on a defined space. For example, a multiple-choice question is asked of the player as the challenge. The player provides his or her response. Based on the response of the player to the challenge, the player may be switched to a virtual reality environment related to the challenge or response.

The virtual reality environment may provide a perspective or viewpoint that allows for navigation within a multi-dimensional (e.g., three-dimensional or 3D) environment. The player may navigate throughout the environment, completing tasks if necessary. Upon completion of the navigation, the game display switches from displaying the virtual reality environment back to displaying the game board.

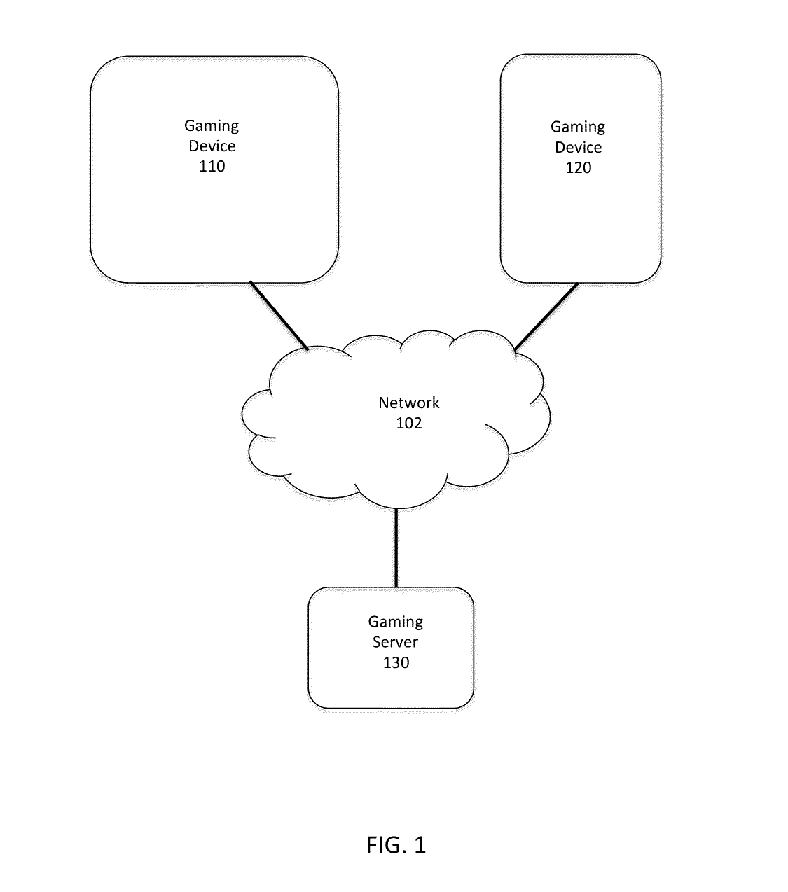

FIG. 1 is a block diagram illustrating example devices for playing electronic games. A game may be played on gaming device 110. Gaming device 110 may be an electronic computing device that includes controllers used by game players to participate in a game displayed on a video display of gaming device 110. A game may be loaded onto gaming device 110 from a memory or computer-readable medium or downloaded from gaming server 130 over network 102. Also, as a non-limiting example, one or more games may be automatically updated on gaming device 110 when updates are made available at gaming server 130.

Network 102 may be any network or combination of networks that can carry data communications. Such a network 102 may include, but is not limited to, a network internal to a home or business, a local area network, metropolitan area network, any ad hoc gaming network, any wired and/or wireless network and wide area network such as the Internet. Network 102 can support protocols and technology including, but not limited to, World Wide Web (or simply the “Web”), protocols such as a Hypertext Transfer Protocol (“HTTP”) protocols, and/or services. Intermediate web servers, gateways, or other servers may be provided between components of the system shown in FIG. 1, depending upon a particular application or environment.

In some cases, gaming device 110 may display the game in coordination with gaming server 130. Multiple players may use gaming device 110. If players play from other locations, these other players may use other gaming devices, such as gaming device 120. In some cases, games may be provided through a browser or any other delivery system to gaming device 110 and/or gaming device 120.

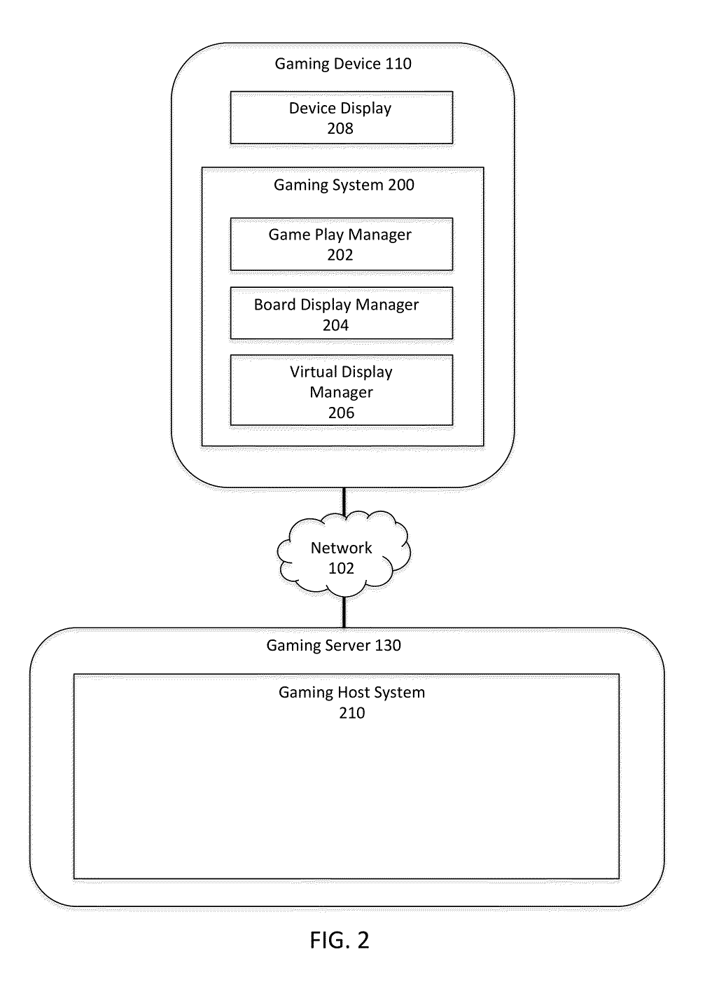

FIG. 2 illustrates a more detailed diagram of a system for playing games, according to an embodiment. Gaming device 110 may include gaming system 200. Gaming system 200 may execute on gaming device 110 and display game play on a display device 208 of gaming device 110.

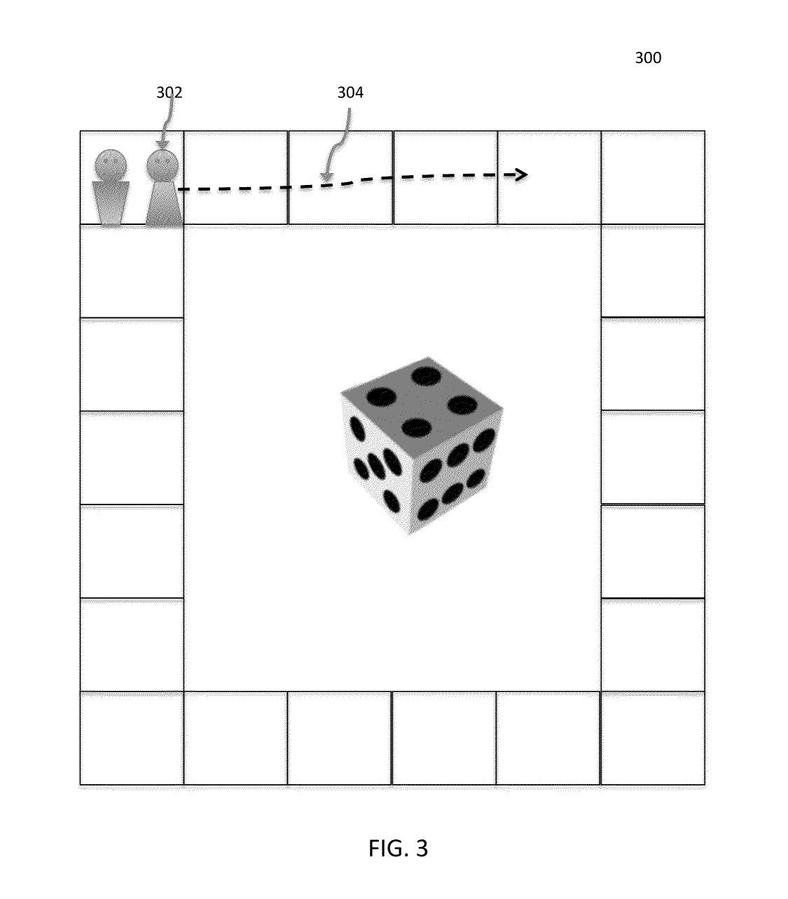

Gaming system 200 may include game play manager 202, board display manager 204 and virtual display manager 206. Board display manager 204 is configured to electronically display a game board on the display 208 of gaming device 110. The game board displayed may be the basis for game play, providing a way to track player movement and determine when a player is presented a challenge. The game board may have a plurality of movement spaces along a path on the face of the game board, for example, the movement spaces shown in display view 300 of FIG. 3. Display view 300 shows an example game board with movement spaces around the perimeter of the board, according to an embodiment. The game board may be more complex and involve many more spaces with words, colors and images particular to a game. The path may follow a square, rectangle, circle, triangle or any other shape or pattern. The game board may be displayed from above the face of the board or from any other angled viewpoint.

When a player starts the game, he or she may enter their basic information, such as name, age, etc. The player can also choose a game piece or an avatar, which would represent them in the system. A player, such as player 302, may perform a player action like rolling a die for a move action 304 to another space. Upon movement to the space, or prior to movement to the space, a challenge may be determined based on the identification of the space or information on the space. Game play manager 202 may be configured to track player positions, movements, scores and any other game play aspects or parameters. Game play manager 202 may also be responsible for determining challenges based on player actions or a space on the game board on which a player has landed.

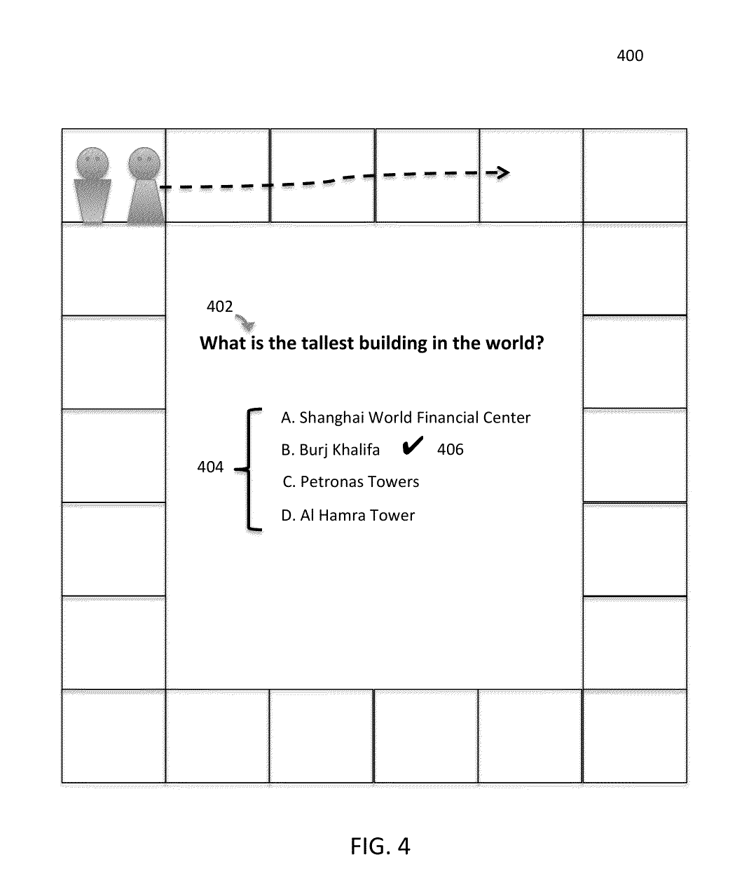

Display view 400 of FIG. 4 shows an example challenge presented to player 302. This particular challenge is a trivia question 402 asking, “What is the tallest building in the world?” A set of responses 404 is displayed, providing multiple choices. The game may be able to directly communicate with the player by name. For example, when a question is asked to a player who entered his name as Jack, the system can say, “Jack, do you know the answer to this question?” If Jack is able (not able) to answer the question, then the system can give a personal message, such as “Nice going, Jack!” or “Sorry, Jack, that's not correct.”

Game play manager 202 receives the answer through a controller or mouse, through a touchscreen gesture, through an audio response, or through any other interface using game device 110.

In this case, the challenge response selected is “B” or “Burj Khalifa.” Game play manager 202 determines if response 406 is correct. It is the correct response and upon that determination, game play manager 202 decides to provide an associated reward or additional challenge by switching from displaying a game board to displaying a virtual reality environment. Virtual display manager 306 now manages the display of the game in a 3D virtual reality environment.

In an example virtual reality environment associated with the challenge response, a tour of the Burj Khalifa building is provided. The virtual reality environment is displayed from a viewpoint that allows navigation through the virtual reality environment. This viewpoint may be a first person viewpoint. This viewpoint may also be from a viewpoint that shows a representation or avatar of player 302 or a third person viewpoint. This third person viewpoint may be as if close to the player so it is effectively a first person viewpoint. In some cases, the viewpoint may vary based on the nature of the virtual environment.

In this example, after switching from the game board display in display view 400, display view 500 may be displayed. The switch may be nearly instantaneous. There may also be an intermediary explanation, instruction or visual when switching to the virtual reality environment display from the game board display. Board display manager 204 may work in coordination with virtual display manager 206 or delegate or transfer responsibility for display to virtual display manager 206.

Display view 500 shows the Burj Khalifa 504 as from near the base of the tower. The environment may show images, animations, representations or other displays to provide a virtual environment. Player avatar 502 is used to show an initial position of the navigation. The player may navigate all around the environment, viewing the location in all directions. The player may view the tower up and down and then proceed to enter the tower. As the player navigates, the surrounding display adjusts to change the display and provide a realistic view of the location.

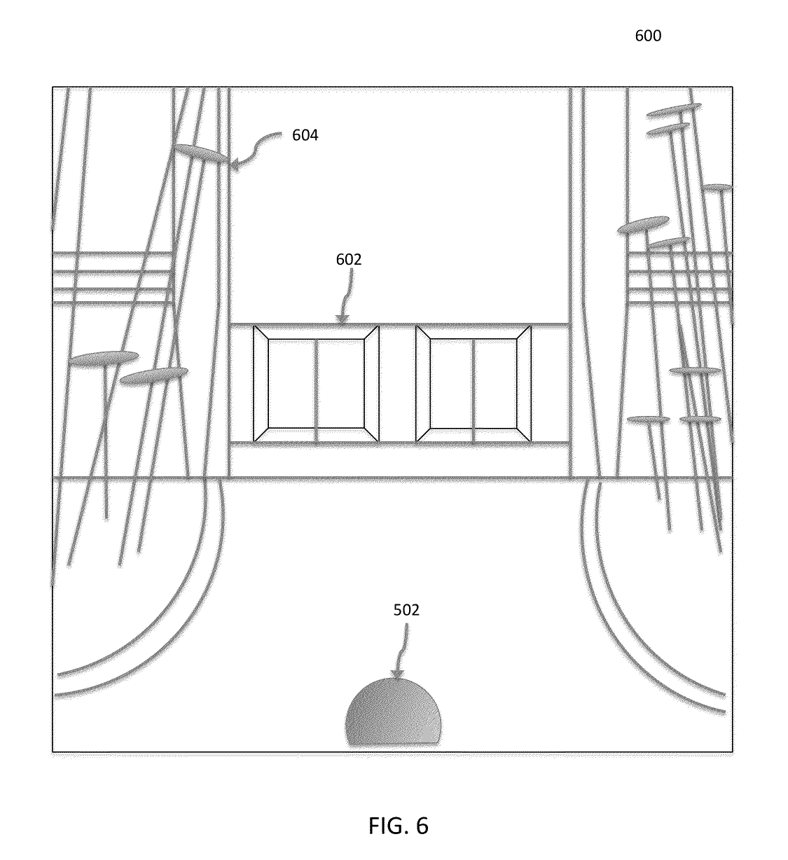

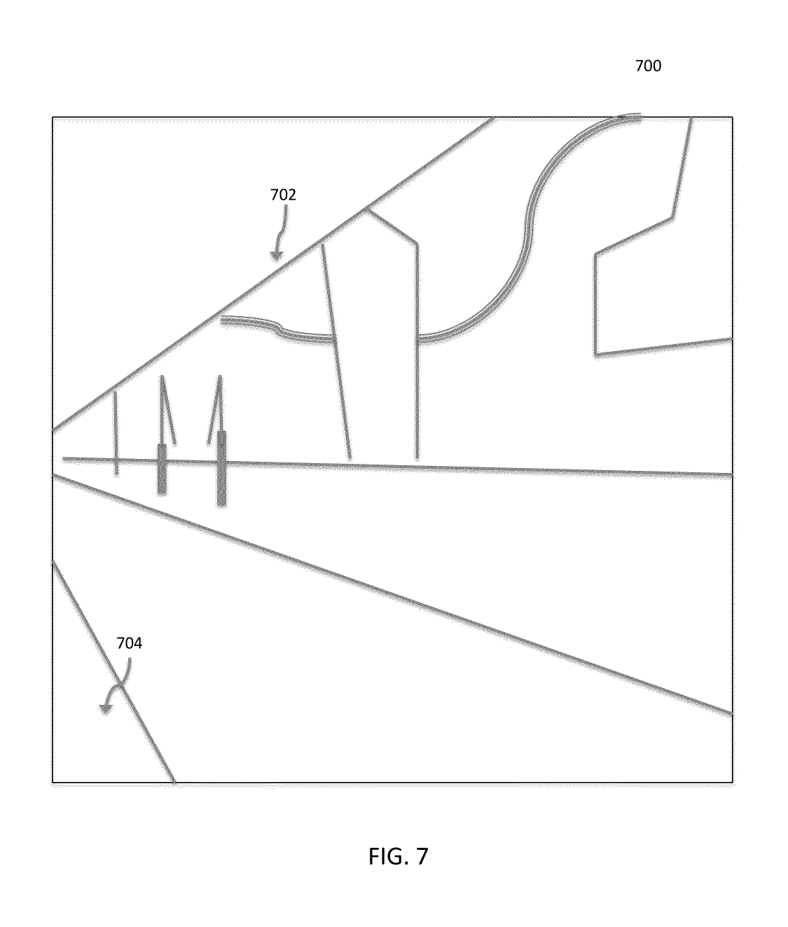

For example, upon navigation to enter the building, a view of the lobby is displayed in display view 600 of FIG. 6. The lobby is lit with natural light and there is a path to doors 602. On either side of the path, portions of the sculpture 604 by artist Jaume Plensa are visible. This display and other visual displays are available during the navigation of the virtual reality environment. For example, navigation to another area shows another view of the inside of the Burj Khalifa. In FIG. 7, a long mural 702 is shown along path 704 in display view 700. The length of mural 702 is displayed as one proceeds along path 704.

Virtual display manager 206 may also be configured to provide for navigation to certain locations, discovery of hidden items, or additional tasks within the environment. For example, there may be a ticket located somewhere on the first floor that grants access to the Burj Khalifa's observation tower. In another example, a player is asked to go to the observation tower and locate a landmark in order to learn more about Dubai, the city where the Burj Khalifa is located. Goals presented to players can help a player to increase his or her score, item collection, rank or cash holdings. If the tasks vary or incrementally improve upon each visit, players will be further motivated to play the game and increase their knowledge.

The player may complete navigation of the virtual display. Navigation may be completed when the player selects to exit the navigation. Navigation may also be considered complete when the player reaches a certain checkpoint, finds a certain object, performs a certain task, meets a virtual character, achieves a goal, or performs any other specified action.

Upon completion of navigation, virtual display manager 206 initiates a switch back to the game board display. This switch may occur manually or automatically. The switch may happen immediately, or following an intermediate instruction, animation or visual.

In an embodiment, the board game will be interactive in nature. Players can have the ability to go from a board game to virtual reality and back to a board game during the course of play. Players may receive a life-like experience of being in a certain place at a certain time, such as at a famous landmark or somewhere in the solar system. Players may experience talking to a famous person such as a scientist or a leader of a nation. The experiences may depend on the category of challenges selected. This method of interactive play will not only help with enhancing knowledge about the subject matter, but also create additional interest on that topic by providing a more realistic feeling of being in that time or place.

A few more examples are provided. Assume a player lands in a category of “Famous Landmarks”. The game recognizes the player and calls him by name. “John, can you name the official residence of a sitting US president?” If John selects, “The White House” as his response, then the system will be able to communicate to John that he has chosen correctly. In addition, display will switch to a 3D image of the White House. John's avatar can now take a 360 degree or panoramic tour of the building. There may also be hidden fun facts, within the perimeters of the building that John may wish to find. This will further enhance the learning experience as well as help John get additional game points.

In another example, player Jane lands within the category of “U.S. Presidents” on the game board and gets the question, “Who is the first U.S. president?” If Jane selects, “George Washington,” then she will be switched to a virtual reality environment display where she is greeted by a life-like image of President Washington, who will congratulate her for selecting the right answer. She may also be able to move around the room and learn additional fun facts from the president himself.

By creating this interactive experience for learning, a player will be further motivated to answer the question correctly so that they get the feeling of being in that place. This will enhance the experience of playing the game and make it unique from other currently available trivia games.

In addition, each player will also be able to keep a record of the places they visited, the people they met, the wild animals they saw during gameplay, etc. There can be virtual prizes for traveling around the globe, or meeting certain celebrities or touring the Milky Way. This creates an additional sense of accomplishment and motivation to learn as they play this interactive game of knowledge, entertainment and chance. These examples are purely illustrative and are not intended to limit the embodiments.

The game can be played as a video game on any computer or on any popular game consoles. The game may also be played online such as by logging into a website. Players will be able to join a virtual game room and compete with others across the globe. There could also be online tournaments, where players compete to win prizes. For example, a competition may be held where the game is played at multiple levels. As one continues to progress through these levels, they can win virtual (or real) prizes depending on how the game is set up.

Gaming system 200 may work independently on gaming device 110. Gaming system 200 may also communicate with other gaming devices, such as gaming device 120 over network 102. However, gaming system 200 may also receive assistance from gaming server 130. FIG. 2 shows gaming host system 210 executing on gaming server 130. In an implementation, gaming host system 210 operates to provide game information and data to gaming system 200. Gaming host system 210 also coordinates game play between gaming system 200 on gaming device 110 and game play on another gaming device, such as on gaming device 120. Updates to the game are made on gaming host system 210 and propagated to gaming system 200.

In another implementation, gaming host system 210 may provide the functionality of gaming system 200. In this case, the game may be managed and served by gaming host system 210 but displayed through a client portal or display on gaming device 110. In a further implementation, gaming system 200 may display the game through a browser executing on gaming device 110. The browser may be a common or known browser, including a multithreading or multi-process browser. Gaming server 130 may use gaming host system 210 to host or serve the game in a web page with the functionality of gaming system 200. The web page may be displayed in a browser executed on gaming device 110. What is displayed in the browser on gaming device 110 may coordinate with what is displayed in a browser on gaming device 120 or any other gaming devices.

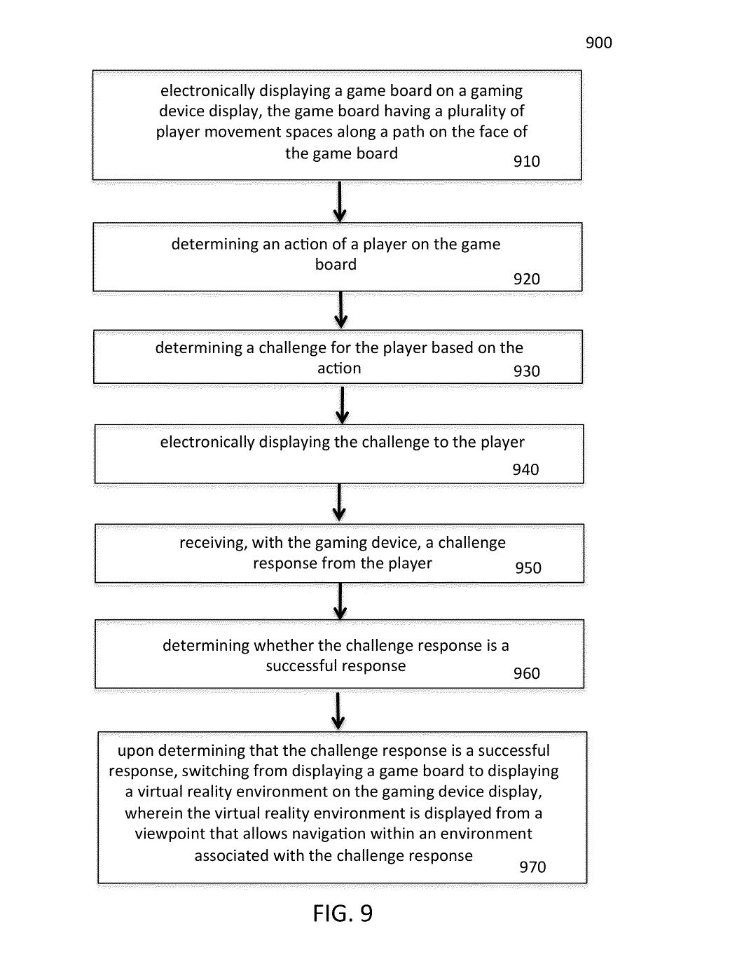

FIG. 9 is a flowchart illustrating an example method 900 for providing an electronic game. At stage 910, a game board is electronically displayed on a gaming device display. The game board has a plurality of movement spaces along a path on the face of the game board. The game board serves as the basis for tracking player movement, determining challenges and recording player progress. Different game boards may be displayed each game, but the display during regular progress of the game involves display of the game board or a recognizable representation of a game board. As an example, board display manager 204 displays the game board on the display of gaming device 110.

At stage 920, an action of a player on the game board is determined. The action may involve movement to a space on the board. The space on the board may indicate what challenge is to be presented. Other actions on the game board in relation to other players may also initiate a challenge.

At stage 930, a challenge is determined for the player based on the action. For example, the movement space that a player lands on may indicate a category of a question to be asked. A question may be chosen based on a certain level of difficulty. In some cases, this difficulty level may be determined dynamically based on past responses of the player. The challenge responses of other players may also be considered, including an average of previous challenge responses for all players. It may be possible for two or more players to be involved in the same challenge.

At stage 940, the challenge is electronically displayed to the player. The challenge may be a question displayed with several responses to choose from or it may be displayed without possible responses. The challenge may be a more open ended question or a problem to be solved. Any variety of challenges may be presented. Challenges may be drawn from a repository of questions or drawn dynamically from another source, memory or computing device.

At stage 950, a challenge response is received from the player. The response may be received through an audio or video input, a controller, touching the screen, through a mouse or keyboard or any other user interface. The challenge response may be a simple selection of an answer. In other cases, a response could be the completion of a puzzle or problem. Various types of challenges may be presented, resulting in various types of challenge responses.

At stage 960, it is determined whether the challenge response is a successful response. A successful response may be the correct answer, a completion of a task, a problem solved or any other determination that a response met a certain benchmark or criteria. In some cases, more than one response may be considered correct or some responses may lead to different results though correct. In other cases, some responses may be considered more correct than others. Stages 920-960 may be performed with game play manager 202.

At stage 970, upon determining that the challenge response is a successful response, the game display is switched from displaying a game board to displaying a virtual reality environment. The switch may take place instantaneously or under certain conditions. The switch itself may involve an animation or game interaction. A player may be offered a choice during the switch or prior to the switch. The switch may be conditioned on what challenge response was presented. What the game switches to may also be conditioned upon the challenge response. A game switch may be selected from multiple possible switches or types of switches.

The virtual reality environment is displayed from a viewpoint that allows navigation within an environment associated with the challenge response. Changes to the virtual reality environment are displayed as the player uses the gaming device for navigation throughout the virtual reality environment. The virtual reality environment can represent an educational visit to a location, an educational visit with a graphical representation of a famous person, an object, an animal, a concept, or a simulation of an educational activity. Educational activities may include, but are not limited to, science experiments, math problems, simulated discoveries or excavations, construction activities, interaction in battles or historical events, problems to be solved or any other activity that has an educational context that conveys knowledge of a historical or current educational topic.

Upon completion of the navigation, the display may be switched from displaying the virtual reality environment back to displaying the game board. Completion of the navigation may include accomplishing a presented goal for the navigation. This may involve navigation to items or tasks within the virtual reality environment.

Virtual reality environment sessions for each player may be tracked and players may be rewarded based on performance in a specified number of educational virtual reality environment sessions. For example, a person may receive a virtual prize for traversing the globe. Different geographical paths may be taken in each game to gain a reward. Players may be motivated to accomplish the different global paths or global regions or to meet certain individuals. Through incremental achievements, players can improve in points, money, rank or prestige. Such accomplishments may be communicated to friends and other players. Virtual display manager 206 displays the virtual reality environment and provides for switching back to display of the game board.

### Dynamic Skill Level

Each time, or over time, the game is played, the difficulty level of the questions are allocated dynamically based on the player's skill sets and their ability to answer prior questions in that category. In an implementation, this is accomplished by using a probability distribution to predict the level of difficulty of the future question based on the aggregate results from the prior questions.

In this example, game play manager 202 uses an interpretation of Bayes' theorem, a theorem that is known in the art of game theory, to predict the level of difficulty of a future question based on the player's ability to answer prior questions. For example, consider a simple situation where questions in a given category are categorized as “easy” or “difficult”. Let p=probability of observing a “difficult” question (1−p=probability of observing an easy question). At the beginning of a game (or the first time the game is being played in the device) there can be an equal chance of getting an “easy” or “difficult” question, i.e., the prior belief of getting an easy or difficult question is equivalent to tossing a coin. Therefore the chance of obtaining a “difficult” question, p follows a uniform (0,1) distribution (p˜U(0,1)).

The likelihood of observing the current set of data (of easy or difficult questions) can be computed for given values of p. The value of p that maximizes the chance of observing this data may be estimated. This likelihood function will follow a binomial distribution (L(X|p)˜bin(n,p)), where n=total number of observations and X denotes the set of observations up to that time point. Therefore, applying Bayes' rule, a posterior distribution of p can be computed as the product of the likelihood function and the prior. In this special case, where a uniform prior, and a binomial likelihood function are used, this will follow a beta distribution, which is also a closed form parametric distribution. Therefore, at each turn, the posterior distribution can be updated based on the current set of data. The probability of getting a “difficult” question can be predicted based on this updated distribution. For example, based on the current play, if the predicted probability of getting a difficult question is 80%, then the player will have a 4 out of 5 chance of getting a difficult question in the next turn.

In an example related to using Bayes' theorem, the level of difficulty of a challenge can be dynamically determined by calculating a probability of a challenge difficulty level based on a function (e.g., a product) of the likelihood of getting a question of the difficulty level and the distribution of previous challenge responses of each player at the difficulty level. The likelihood may be a likelihood function that is defined by parameters for probabilities of getting questions at a certain difficulty level. The prior distribution may be specific to a difficulty level or a distribution of all difficulty levels. The resulting predicted probability may be used to select a level of difficulty for the challenge.

To make the game fair for both players or for more than two players, the probabilities may be updated based on the aggregate data from all the players, which will average out any differences in skill set and not penalize any player for being better at the game. For example, if a player is able to answer a question repeatedly in a category, then the level of difficulty of the question will tend to go up. However, if the predictions are based on the combined results from all the players, it may predict based on the average skill levels.

The average skill level, average past probability of receiving challenges at a certain difficulty level, or average challenge response success rate may be considered when determining a prior probability distribution. Other players may be factored in calculating a current probability of a difficulty level or transforming that probability into a selection of a difficulty level. Difficulty levels may be selected based on a certain probability threshold or criteria.

Difficulty levels may be easy or difficult. Difficulty levels may be stratified into multiple levels. Based on the history or progress of players, an easy or difficult question at one point in time may be different than an easy or difficult question at another point in time.

There may be opportunities to further refine the selection of the question by selecting models that allows for the use of other baseline data. For example, the players can input additional information such as his or her age. The system can utilize that information in predicting the chance of getting an easy or difficult question. For example, the model might determine that a player who is 7 years old may have a higher probability of getting an easy question compared to a 17 year old (provided all other conditions are equal).

If the game is being played online, players can provide basic demographic information while logging in to the website. Various modeling techniques can be used that utilize this data to predict the probability that a subject will be able to respond correctly and select the level of question accordingly. For example, suppose a school system adopts this game as a means of learning and fun activity for children. Then, by selecting questions based on demographics and other basic characteristics, such as age or grade level, prior test scores, etc., the questions can be appropriately geared for the right audience and the level of learning activity can be made more interesting. Here is a specific example demonstrating how this may be implemented. Suppose, data is collected from several players over time, including their responses, and different demographic and baseline characteristics. A logistic regression model may be fitted which will model the probability of responding to a difficult question (p) on those baseline covariates. This fitted regression model may then be used to predict a new player's ability to respond, given their age, gender, grade level, test scores, etc.

Systems 200 and 210 may be software, firmware, or hardware or any combination thereof in a computing device. Systems 200 and 210 may be software in a browser or software displayed by a browser, the browser being software executed on a computing device. A computing device, such as gaming device 110, gaming server 130 and any other gaming device 120 can be any type of computing device having one or more processors. The computing device may also contain computer readable memory. For example, a computing device can be a computer, server, workstation, mobile device (e.g., a mobile phone, personal digital assistant, navigation device, tablet, laptop or any other user carried device), game console, set-top box, kiosk, embedded system or other device having at least one processor and memory. A computing device may include a communication port or I/O device for communicating over wired or wireless communication link(s).

Computing devices such as a monitor, all-in-one computer, smart phone, tablet computer, remote control, etc., may include a touch screen display that accepts user input via touching operations performed by a user's fingers or other instrument. For example purposes, a touch sensor grid may overlay the display area. The touch sensor grid contains many touch sensitive areas or cells that may be used to locate the area closest to the input of a user's touch.

Example touch operations using a touch screen display may include (but are not limited to) pinching, finger (or other stylus or object) touches, finger releases, and finger slides. The touch screen display may include a screen or monitor that may render text and/or images.

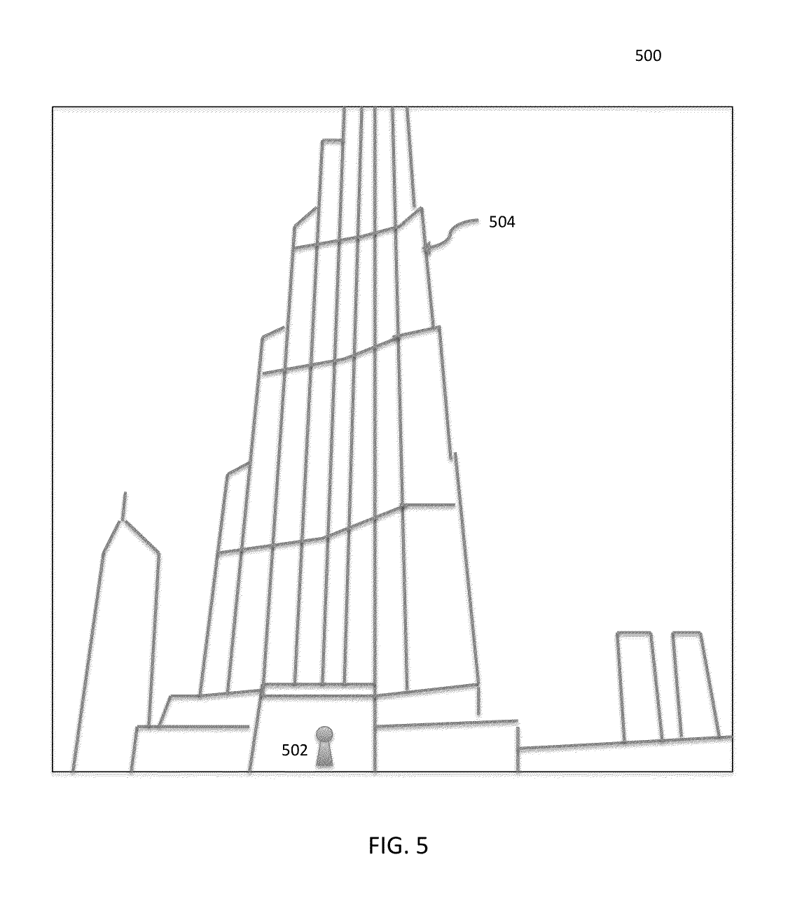

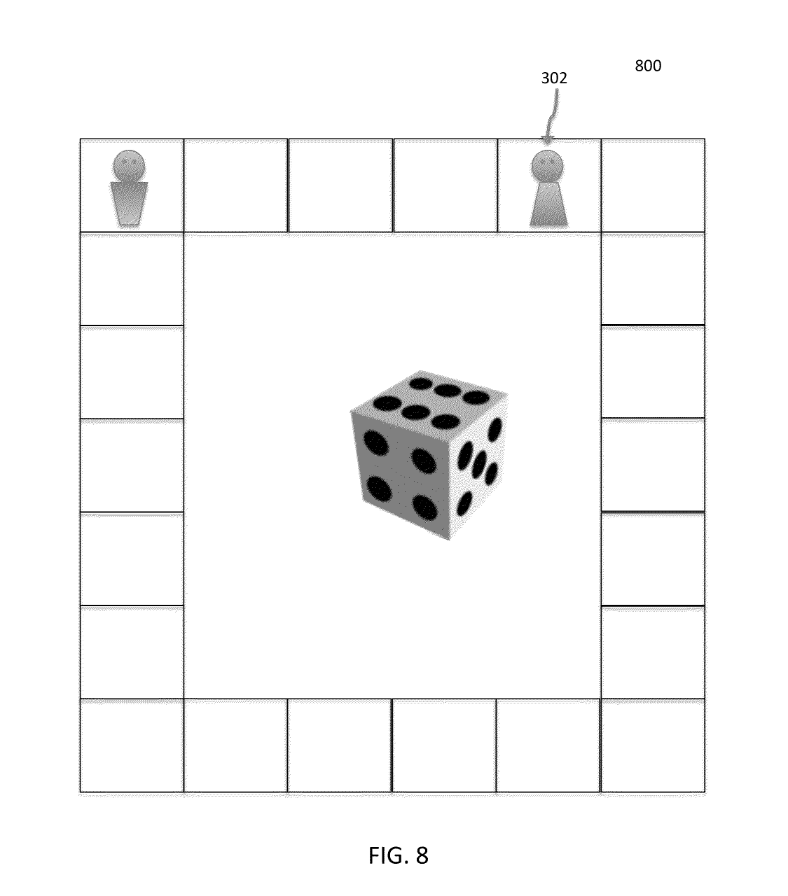

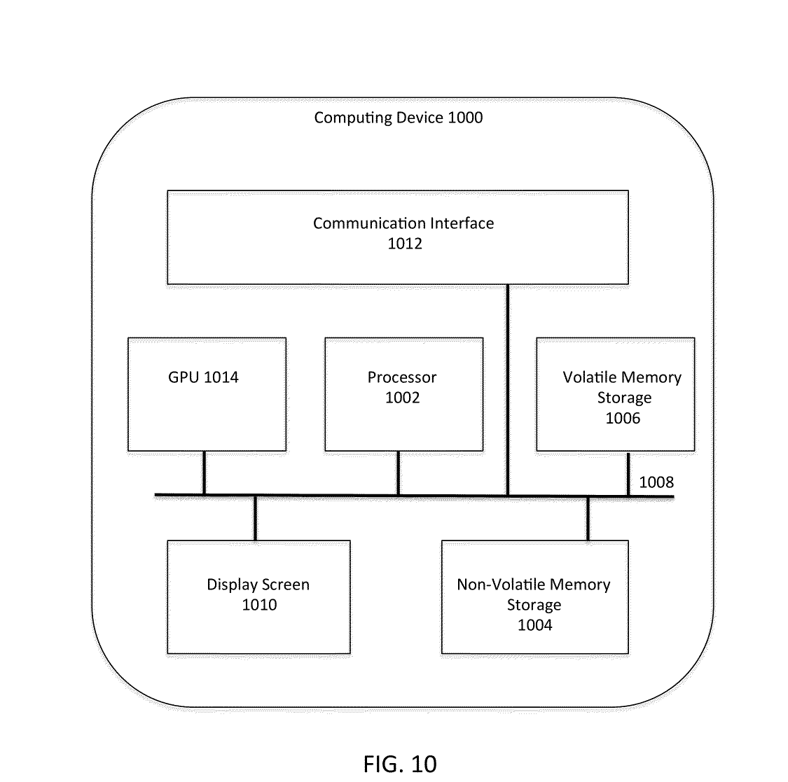

FIG. 10 is an example computer system 1000 in which embodiments of the present invention, or portions thereof, may be implemented as computer-readable code. For example, the components of systems 200 or 210 may be implemented in one or more computer systems 1000 using hardware, software implemented with hardware, firmware, tangible computer-readable media having instructions stored thereon, or a combination thereof and may be implemented in one or more computer systems or other processing systems. Components in FIGS. 1-8 and method 900 may be embodied in any combination of hardware and software.

Computing devices, such as gaming devices 110 and 120 or gaming server 130, may include one or more processors 1002, one or more non-volatile storage mediums 1004, one or more memory devices 1006, a communication infrastructure 1008, a display screen 1010 and a communication interface 1012.

Processors 1002 may include any conventional or special purpose processor, including, but not limited to, digital signal processor (DSP), field programmable gate array (FPGA), application specific integrated circuit (ASIC), and multi-core processors.

GPU 1014 is a specialized processor that executes instructions and programs, selected for complex graphics and mathematical operations, in parallel.

Non-volatile storage 1004 may include one or more of a hard disk drive, flash memory, and like devices that may store computer program instructions and data on computer-readable media. One or more of non-volatile storage device 1004 may be a removable storage device.

Memory devices 1006 may include one or more volatile memory devices such as but not limited to, random access memory. Communication infrastructure 1008 may include one or more device interconnection buses such as Ethernet, Peripheral Component Interconnect (PCI), and the like.

Typically, computer instructions are executed using one or more processors 1002 and can be stored in non-volatile storage medium 1004 or memory devices 1006.

Display screen 1010 allows results of the computer operations to be displayed to a user or an application developer.

Communication interface 1012 allows software and data to be transferred between computer system 1000 and external devices. Communication interface 1012 may include a modem, a network interface (such as an Ethernet card), a communications port, a PCMCIA slot and card, or the like. Software and data transferred via communication interface 1012 may be in the form of signals, which may be electronic, electromagnetic, optical, or other signals capable of being received by communication interface 1012. These signals may be provided to communication interface 1012 via a communications path. The communications path carries signals and may be implemented using wire or cable, fiber optics, a phone line, a cellular phone link, an RF link or other communications channels.

Embodiments also may be directed to computer program products comprising software stored on any computer-usable medium. Such software, when executed in one or more data processing device, causes a data processing device(s) to operate as described herein. Embodiments of the invention employ any computer-usable or readable medium. Examples of computer-usable mediums include, but are not limited to, primary storage devices (e.g., any type of random access memory), secondary storage devices (e.g., hard drives, floppy disks, CD ROMs, ZIP disks, tapes, cartridges, thumb drives, flash drives, magnetic storage devices, and optical storage devices, MEMS, nanotechnological storage device, etc.).

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein.

The breadth and scope of the present invention should not be limited by any of the above-described exemplary embodiments or any actual software code with the specialized control of hardware to implement such embodiments, but should be defined only in accordance with the following claims and their equivalents.

What is claimed is:

1. A computer-implemented method for providing an electronic game, comprising:
electronically displaying a game board on a gaming device display, the game board having a plurality of player movement spaces along a path on the face of the game board;
determining an action of a player on the game board;
determining a challenge for the player based on the action;
electronically displaying the challenge to the player;
receiving, with the gaming device, a challenge response from the player;
determining whether the challenge response is a successful response; and
upon determining that the challenge response is a successful response, switching from displaying a game board to displaying a virtual reality environment on the gaming device display, wherein the virtual reality environment is displayed from a viewpoint that allows navigation within an environment associated with the challenge response.

2. The method of claim 1, further comprising:
displaying changes to the virtual reality environment as the player uses the gaming device for navigation throughout the virtual reality environment.

3. The method of claim 1, further comprising:
upon completion of the navigation, switching from displaying the virtual reality environment back to displaying the game board.

4. The method of claim 3, wherein completion of the navigation comprises accomplishing a presented goal for the navigation.

5. The method of claim 4, wherein completion of the navigation comprises navigation to items or tasks within the virtual reality environment.

6. The method of claim 1, wherein the virtual reality environment represents at least one of an educational visit to a location, an educational visit with a graphical representation of a famous person, an object, an animal, a concept, and a simulation of an educational activity.

7. The method of claim 1, further comprising:
tracking virtual reality environment sessions for each player; and
determining a reward for a player based on performance in a specified number of educational virtual reality environment sessions.

8. The method of claim 1, wherein determining a challenge for the player comprises:
dynamically selecting a level of difficulty of the challenge based on previous challenge responses of the player.

9. The method of claim 8, wherein selecting a level of difficulty comprises calculating a probability of a challenge difficulty level based on a product of the likelihood of getting a question of the difficulty level and the distribution of previous challenge responses of each player at the difficulty level.

10. A system for providing an electronic game, comprising: one or more computer-readable storage media; and software embodied in the one or more computer-readable storage media that is operable when executed to:
electronically display a game board on a gaming device display, the game board having a plurality of player movement spaces along a path on the face of the game board;
determine an action of a player on the game board;
determine a challenge for the player based on the action;
electronically display the challenge to the player;
receive, with the gaming device, a challenge response from the player;
determine whether the challenge response is a successful response;
upon determining that the challenge response is a successful response, switch from displaying a game board to displaying a virtual reality environment on the gaming device display, wherein the virtual reality environment is displayed from a viewpoint that allows navigation within an environment associated with the challenge response.

11. The system of claim 10, wherein the computer-readable storage medium is further operable, when executed to:
upon completion of the navigation, switch from displaying the virtual reality environment back to displaying the game board.

12. The system of claim 11, wherein completion of the navigation includes accomplishing a presented goal for the navigation.

13. The system of claim 10, wherein the virtual reality environment represents at least one of an educational visit to a location, an educational visit with a graphical representation of a famous person, an object, an animal, a concept, and a simulation of an educational activity.

14. The system of claim 10, wherein the computer-readable storage medium is further operable, when executed to:
track virtual reality environment sessions for each player; and
determine a reward for a player based on performance in a specified number of educational virtual reality environment sessions.

15. The system of claim 10, wherein determining a challenge for the player comprises dynamically selecting a level of difficulty of the challenge based on previous challenge responses of the player.

16. A computer readable storage medium having computer-executable instructions stored thereon and executable by a processing system and operable to cause the processing system upon such execution to perform operations comprising:
electronically displaying a game board on a gaming device display, the game board having a plurality of player movement spaces along a path on the face of the game board;
determining an action of a player on the game board;
determining a challenge for the player based on the action;
electronically displaying the challenge to the player;
receiving, with the gaming device, a challenge response from the player;
determining whether the challenge response is a successful response; and
upon determining that the challenge response is a successful response, switching from displaying a game board to displaying a virtual reality environment on the gaming device display, wherein the virtual reality environment is displayed from a viewpoint that allows navigation within an environment associated with the challenge response.

17. The computer readable storage medium of claim 16, wherein the operations further comprise:
upon completion of the navigation, switching from displaying the virtual reality environment back to displaying the game board.

18. The computer readable storage medium of claim 16, wherein the virtual reality environment represents at least one of an educational visit to a location, an educational visit with a graphical representation of a famous person, an object, an animal, a concept, and a simulation of an educational activity.

19. The computer readable storage medium of claim 16, further comprising:
tracking virtual reality environment sessions for each player; and
determining a reward for a player based on performance in a specified number of educational virtual reality environment sessions.

20. The computer readable storage medium of claim 19, wherein determining a challenge for the player comprises dynamically selecting a level of difficulty of the challenge based on previous challenge responses of the player.
